(19) United States
(12) Patent Application Publication
(10) Pub. No.: US 2010/0195016 A1
(43) Pub. Date: Aug. 5, 2010

(54) BACKLIGHT UNIT AND LIQUID CRYSTAL DISPLAY DEVICE

(75) Inventor: Hideki Koh, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/679,332

(22) PCT Filed: Jul. 14, 2008
(86) PCT No.: PCT/JP2008/062672

§ 371 Date: Mar. 22, 2010

(30) Foreign Application Priority Data
Sep. 25, 2007 (JP) 2007-246587

(51) Int. Cl. G02F 1/1333; G02F 1/13357

(52) U.S. Cl. 349/58; 362/97.1

(57) ABSTRACT

A backlight unit (82) is provided that includes a plurality of fluorescent tubes (171) that are aligned and a plurality of lamp clips (LC) that hold the fluorescent tubes (171). In the backlight unit (82), when a direction in which the fluorescent tubes (171) extend is an X-direction and a direction in which the fluorescent tubes (171) are aligned is a Y-direction, in a plane defined by the X-direction and the Y-direction, at least three types of lamp clips (LC) arranged in different positions in the X-direction are included.

### TECHNICAL FIELD

The present invention relates to a backlight unit and a liquid crystal display device incorporating such a backlight unit.

### BACKGROUND ART

Generally, liquid crystal itself within a liquid crystal display panel emits no light. Thus, a liquid crystal display device takes in sunlight or the like as external light, and utilizes the external light to display various images on the liquid crystal display panel. Then, with it being kept in mind that it may be impossible to take in the external light, it is preferable that the liquid crystal display device include a device (backlight unit) which emits light to the liquid crystal.

There are various types of backlights. For example, as shown in FIG. 15, there is provided a direct backlight unit 182 (see patent document 1) in which a plurality of fluorescent tubes (linear light sources) 171 are aligned to face the back of a liquid crystal panel.

Incidentally, in such a backlight unit 182, both ends of the fluorescent tubes 171 are held by lamp holders hd, and portions other than these ends are held by lamp clips (holding clips) lc. The fluorescent tubes 171 receive alternating-current signals of several tens of thousands of hertz supplied from an unillustrated inverter, and thereby emit light. The brightness of the fluorescent tubes 171 that emit light is adjusted with 100 to 500 Hz alternating-current signals called light control signals.

Patent document 1: JP-A-2006-32358 (see FIG. 1)

### DISCLOSURE OF THE INVENTION

### Problems to be Solved by the Invention

If, in the backlight unit 182 as shown in FIG. 15, a backlight frame 172 for accommodating the fluorescent tubes 171 is formed of a metal (conductor), a problem arises. The problem is caused by distributed capacitance (parasitic capacitance) that is produced between the fluorescent tubes 171 to which the alternating-current signals are supplied and the metallic backlight frame 172.

This problem will be specifically described below. Generally, the parasitic capacitance produced by the on signals of alternating-current signals generates an electromagnetic force on the fluorescent tubes 171, and the fluorescent tubes 171 affected by the electromagnetic force is displaced with respect to the backlight frame 172 (displaced to move close to the backlight frame 172). On the other hand, the electromagnetic force is eliminated by the off signals of the alternating-current signals, and the fluorescent tubes 171 that are not affected by the electromagnetic force are returned to the original position (displaced to move away from the backlight frame 172).

Specifically, the fluorescent tubes 171 move close to or away from the backlight frame 172 according to the electromagnetic force that is produced or eliminated by the alternating-current signals, and this causes the fluorescent tubes 171 to vibrate. The vibrating fluorescent tubes 171 also resonate. Thus, they have a resonant frequency.

The resonant frequency is changed due to the lamp clips lc holding the fluorescent tubes 171. Thus, as shown in FIG. 15, lamp clips lc1 are disposed in the same position in a direction in which the fluorescent tubes 171 extend, and lamp clips lc2 are disposed in a position different from that of the lamp clips lc1 in the direction in which the fluorescent tubes 171 extend, with the result that the following problem arises.

The fluorescent tubes 171 held by the lamp clips lc1 have a resonant frequency λ1 depending on the position of the lamp clips lc1. The fluorescent tubes 171 held by the lamp clips lc2 also have a resonant frequency λ2 depending on the position of the lamp clips lc2.

Hence, each of the fluorescent tubes 171 held by the lamp clips lc1 disposed in the same position in the direction in which the fluorescent tubes 171 extend has the resonant frequency λ1; their resonant frequencies λ1 are superimposed on each other. Likewise, each of the fluorescent tubes 171 held by the lamp clips lc2 has the resonant frequency λ2; their resonant frequencies λ2 are superimposed on each other.

Thus, in the backlight unit 182, an unusual sound is produced due to the two types of superimposed resonant frequencies. Specifically, a plurality of fluorescent tubes 171 are included in the direct backlight unit 182, and, when the resonant frequencies of the fluorescent tubes 171 are superimposed (concentrated) into the two types of resonant frequencies without being spread, the unusual sound is made larger.

The concentrated unusual sound is produced even when the lamp clips lc are aligned in the direction in which the fluorescent tubes 171 extend. In other words, even in the case shown in the schematic plan view of FIG. 16 that shows the arrangement of the fluorescent tubes 171 in a plane, an unusual sound is produced.

The backlight unit 182 shown in FIG. 16 will be described in detail. A plurality of lamp clips lc (that is, lamp clips lc holding the same fluorescent tubes 171) arranged both in the same positions in a direction in which the fluorescent tubes 171 are aligned and in the direction in which the fluorescent tubes 171 extend are referred to as a lamp clip set lcs (a part indicated by “}” (a wavy parenthesis) in the figure).

In lamp clip sets lcs1, lcs3, lcs5 and lcs7, the lamp clips lc are arranged in the same position in the direction in which the fluorescent tubes 171 extend. On the other hand, in lamp clip sets lcs2, lcs4 and lcs6, the lamp clips lc are arranged in the same position in the direction in which the fluorescent tubes 171 extend.

Resonant frequencies that are produced by the lamp clip sets lcs1, lcs3, lcs5 and lcs7 are superimposed on each other; resonant frequencies that are produced by the lamp clip sets lcs2, lcs4 and lcs6 are superimposed on each other. Thus, even in such a backlight 182, an unusual sound is produced due to the two types of superimposed resonant frequencies.

The present invention is designed in view of the foregoing situation. An object of the invention is to provide a backlight unit or the like that reduces an unusual sound produced due to the resonant frequencies of vibrating fluorescent tubes.

### Means for Solving the Problem

A backlight unit includes a plurality of linear light sources that are aligned and a plurality of holding clips that hold the linear light sources. In the backlight unit, when a direction in which the linear light sources extend is an X-direction and a direction in which the linear light sources are aligned is a Y-direction, in a plane defined by the X-direction and the Y-direction, at least three types of holding clips arranged in different positions in the X-direction are included.

When a plurality of holding clips arranged in the same position in the Y-direction and aligned in the X-direction are a holding clip set, in all holding clip sets formed, a plurality of pairs of holding clip sets in which positions of the holding clips in the X-direction are the same are preferably included and at least one holding clip set other than the pairs are preferably included.

When a plurality of holding clip sets other than the pairs are included, in the plurality of holding clip sets, at least parts of the positions of the holing clips in the X-direction are preferably different.

In all holding clip sets, one pair of holding clip sets in which positions of the holding clips in the X-direction are the same is preferably included and at least two holding clip sets other than the pair are preferably included.

In all holding clip sets, three or more pairs of holding clip sets in which positions of the holding clips in the X-direction are the same are preferably included.

In the plurality of holding clips, a large group of single holding clips which are arranged in different positions in the Y-direction and in which a single holding clip is arranged in the X-direction are included, and, in the large group of single holding clips, a small group of single holding clips arranged in the same position in the X-direction and a small group of single holding clips arranged in different positions in the X-direction are preferably mixed.

In the plurality of holding clips, at least one holding clip set which is arranged in the same position in the Y-direction and in which a plurality of holding clip sets are aligned in the X-direction is preferably included.

A plurality of holding clip sets are included, and, in all the holding clip sets, at least one pair of holding clip sets in which positions of the holding clips in the X-direction are the same is preferably included.

At least one holding clip set other than the pair is preferably included.

A plurality of holding clip sets other than the pair are included, and, in the plurality of holding clip sets, at least parts of positions of the holing clips in the X-direction are preferably different.

All positions of the holding clips in the X-direction are preferably different.

In the backlight units described above, a supporting stage that supports the linear light sources is preferably arranged at both ends of the linear light sources.

According to one aspect of the present invention, there is provided a liquid crystal display device including the backlight unit described above and a liquid crystal display panel that receives light from the backlight unit.

### ADVANTAGES OF THE INVENTION

According to the present invention, the positions of the holding clips holding the fluorescent tubes are different in the direction in which the fluorescent tubes extend (at least three types of positions are present.) Then, the resonant frequencies of the fluorescent tubes depending on the position of the holding clips are different. Hence, in the entire backlight unit, the resonant frequencies of the fluorescent tubes are not superimposed, and thus an unusual sound produced due to the resonant frequencies is reduced.

### BRIEF DESCRIPTION OF DRAWINGS

FIG. 1 shows the arrangement of fluorescent tubes in a backlight unit, and is a schematic plan view of the backlight unit that includes two pairs of lamp clip sets and one lamp clip set that does not make a pair;

FIG. 2 shows the arrangement of fluorescent tubes in a backlight unit, and is a schematic plan view of the backlight unit that includes two pairs of lamp clip sets and two lamp clip sets that do not make a pair;

FIG. 3 shows the arrangement of fluorescent tubes in a backlight unit, and is a schematic plan view of the backlight unit that includes three pairs of lamp clip sets in which the positions of lamp clips in an X-direction are the same;

FIG. 4 is a schematic plan view of a backlight unit that includes three pairs of lamp clip sets different from those of FIG. 3;

FIG. 5 is a schematic plan view of a backlight unit that includes three pairs of lamp clip sets different from those of FIGS. 3 and 4;

FIG. 6 is a schematic plan view of a backlight unit that includes three pairs of lamp clip sets different from those of FIGS. 3 to 5;

FIG. 7 is a schematic plan view of a backlight unit that includes three pairs of lamp clip sets different from those of FIGS. 3 to 6;

FIG. 8 is a schematic plan view of a backlight unit that includes three pairs of lamp clip sets different from those of FIGS. 3 to 7;

FIG. 9 is a schematic plan view of a backlight unit in which only one lamp clip is arranged in the X-direction;

FIG. 10 is a schematic plan view of a backlight unit that includes a small group of lamp clips arranged in the same position in the X-direction, a small group of lamp clips arranged in different positions in the X-direction and one lamp clip set;

FIG. 11 is a schematic plan view of a backlight unit that includes a small group of lamp clips arranged in the same position in the X-direction, a small group of lamp clips arranged in different positions in the X-direction and two lamp clip sets;

FIG. 12 is a schematic plan view of a backlight unit that includes a small group of lamp clips arranged in the same position in the X-direction, a small group of lamp clips arranged in different positions in the X-direction, a pair of two lamp clip sets and one lamp clip set that does not make a pair;

FIG. 13 is a schematic plan view of a backlight unit that includes a small group of lamp clips arranged in the same position in the X-direction, a small group of lamp clips arranged in different positions in the X-direction, a pair of two lamp clip sets and two lamp clip sets that do not make a pair;

FIG. 14 is an exploded perspective view of a liquid crystal display device;

FIG. 15 is an exploded perspective view of a conventional liquid crystal display device; and

FIG. 16 is a schematic plan view showing the conventional arrangement of lamp clips.

### LIST OF REFERENCE SYMBOLS

LC Lamp clip (holding clip)
LCS Lamp clip set (holding clip set)
SGR Small group (small group of single holding clips arranged in the same position in the X-direction)
DGR Small group (small group of single holding clips arranged in different positions in the X-direction)
71 Fluorescent tube (linear light source)
HD Lamp holder
72 Backlight frame
81 Liquid crystal display panel
82 Backlight unit
89 Liquid crystal display device
X Direction in which the fluorescent tubes extend
Y Direction in which the fluorescent tubes are aligned

### BEST MODE FOR CARRYING OUT THE INVENTION

### Embodiment 1

An embodiment of the present invention will be described below with reference to the accompanying drawings. For convenience, member reference symbols and the like may be omitted, and in this case, other drawings should be referenced.

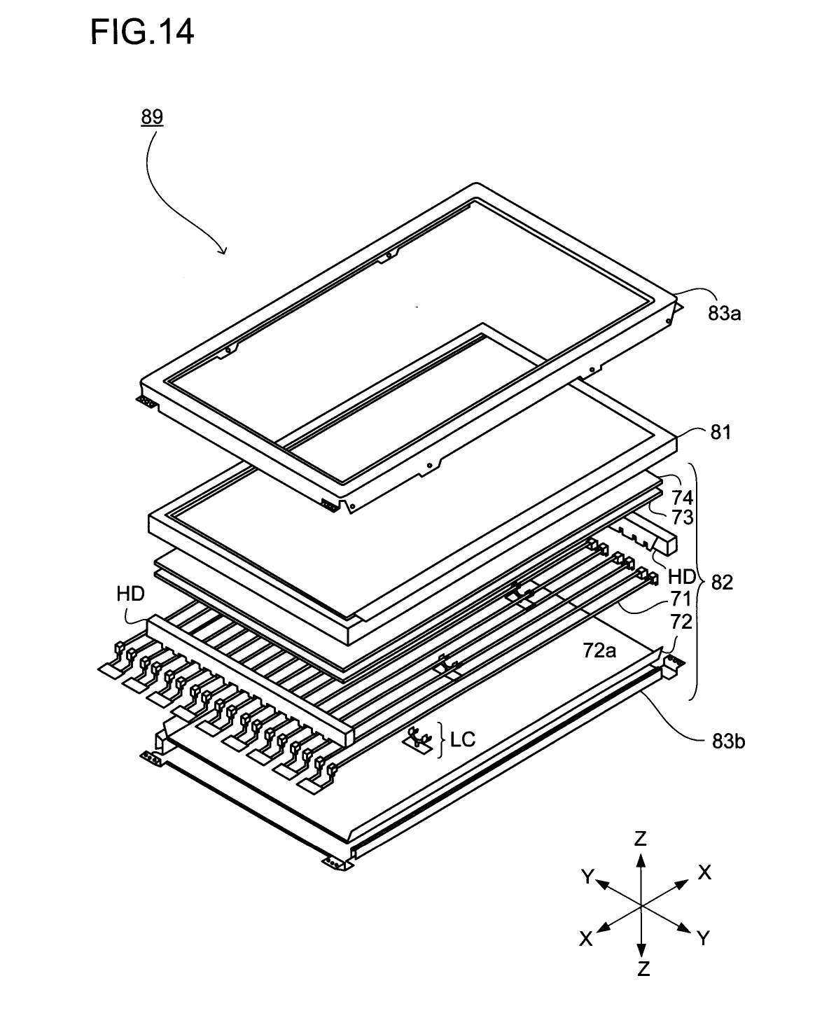

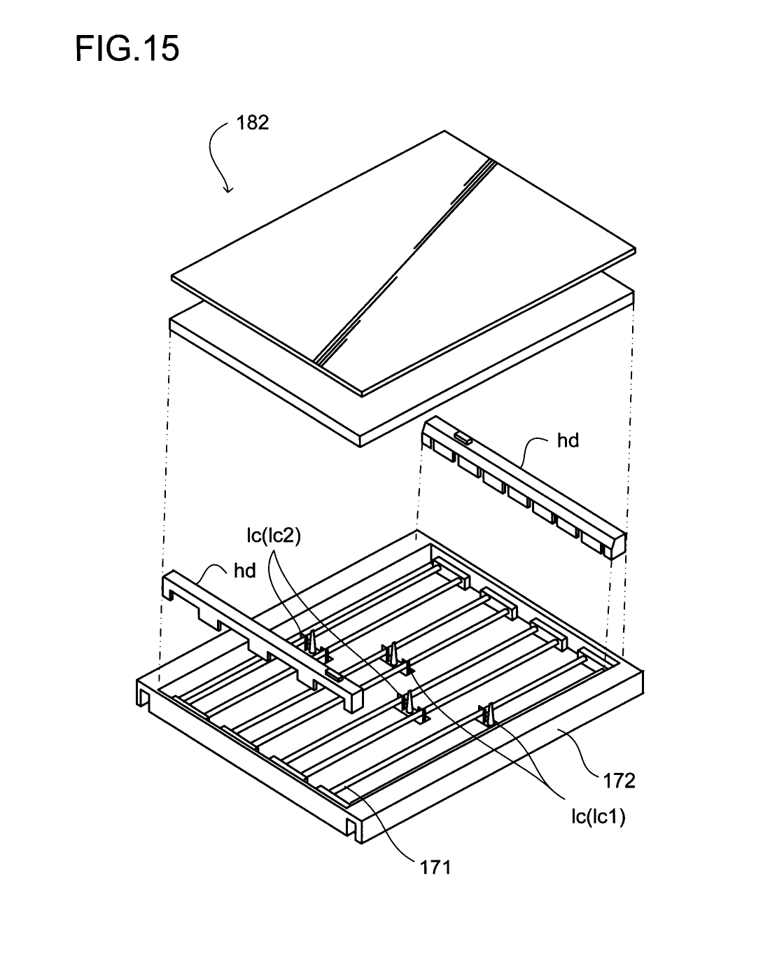

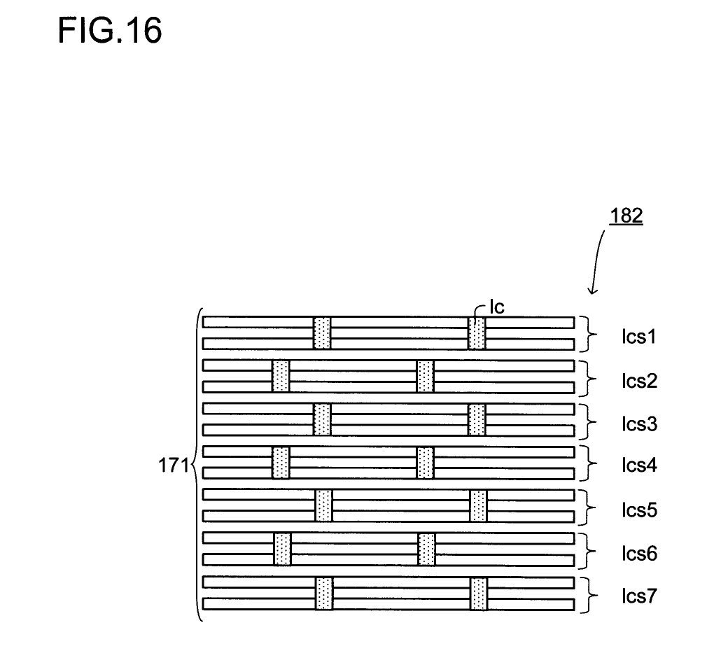

FIG. 14 is an exploded perspective view of a liquid crystal display device. As shown in this figure, the liquid crystal display device 89 includes a liquid crystal display panel 81, a backlight unit 82 and a bezel 83 (83a and 83b) that accommodates these components.

The liquid crystal display panel 81 is a non-light-emitting display panel, and receives light (backlight) from the backlight unit 82 to achieve a display function. Thus, if the light from the backlight unit 82 can be evenly distributed over the entire surface of the liquid crystal panel 81, the display quality of the liquid crystal panel 81 is enhanced.

In order to produce the backlight, the backlight unit 82 includes fluorescent tubes (light sources) 71, a backlight frame 72, a diffusion sheet 73 and an optical sheet 74.

The fluorescent tubes (linear light sources) 71 are linear (rod-shaped, cylindrical or shaped otherwise); a plurality of fluorescent tubes 71 are incorporated in the backlight unit 82 (for convenience, part of fluorescent tubes is only shown in the figure.)

The fluorescent tubes 71 are incorporated in the backlight unit 82 by being supported by lamp holders HD at both ends thereof. In order to stably incorporate the fluorescent tubes 71 in the backlight unit 82, lamp clips LC holding the fluorescent tubes 71 are also incorporated (the arrangement of the lamp clips LC will be described in detail.)

The type of fluorescent tube 71 is not limited. For example, cold-cathode tubes or hot-cathode tubes may be used instead. In the following description, a direction in which the fluorescent tubes 71 are aligned is referred to as a Y-direction, a direction in which the fluorescent tubes 71 extend is referred to as an X-direction and a direction perpendicular to both the X-direction and the Y-direction is referred to as a Z-direction.

The backlight frame 72 is a box-shaped member that has open sides; the inner surfaces of the box-shaped member are coated with a resin, a metal or the like (reflective sheet) having a reflective function. The fluorescent tubes 71 are arranged on the inner surface of the box-shaped member. Thus, part of light (radial light about the fluorescent tubes 71) that is radially emitted from the fluorescent tubes 71 is reflected and guided to the open sides.

The constituent member itself of the backlight frame 72 may be formed of a resin, a metal or the like having a reflective function. This is because a resin, a metal or the like with which the inner surfaces are coated can be removed.

The diffusion sheet 73 is formed of a resin such as polyethylene terephthalate that has both the function of scattering light and the function of diffusing light, and is arranged to cover the aligned fluorescent tubes 71. Thus, when the light emitted from the fluorescent tubes 71 enters the diffusion sheet 73, the light is scattered and diffused in directions along the plane.

The optical sheet 74 is a lens sheet that has, for example, a lens shape in a sheet surface and that has an emission characteristic of deflecting light (focusing light); the optical sheet 74 is arranged to cover the diffusion sheet 73. Hence, the light emitted from the diffusion sheet 73 enters the optical sheet 74 to converge, and this improves light-emission brightness per unit area.

In the backlight unit 82, the backlight frame 72, a group of fluorescent tubes 71 aligned on the inner surface (bottom surface) of the backlight frame 72, the diffusion sheet 73 and the optical sheet 74 are stacked in this order (it should be noted that the direction in which they are stacked coincides with the Z-direction.)

In the backlight unit 82 described above, the fluorescent tubes 71 aligned on the backlight frame 72 through the lamp clips LC receive alternating-current signals supplied from an unillustrated inverter, and thereby emit light.

Either the light directly reaches the diffusion sheet 73 or the light is reflected off the reflective surface (inner surface 72a) of the backlight frame 72 and then reaches the diffusion sheet 73. The light that has reached the diffusion sheet 73 is diffused as it passes through the optical sheet 74, and thus the light is emitted as backlight that has light emission brightness enhanced.

When the fluorescent tubes 71 that receive the alternating-current signals from the inverter and thereby emit light are arranged on the inner surface 72a of the conductive metallic backlight frame 72, distributed capacitance (parasitic capacitance) is produced between the fluorescent tubes 71 and the backlight frame 72 due to the supply of the alternating-current signals from the inverter, in particular, alternating-current signals for light control. An electromagnetic force resulting from the parasitic capacitance causes the fluorescent tubes 71 to vibrate.

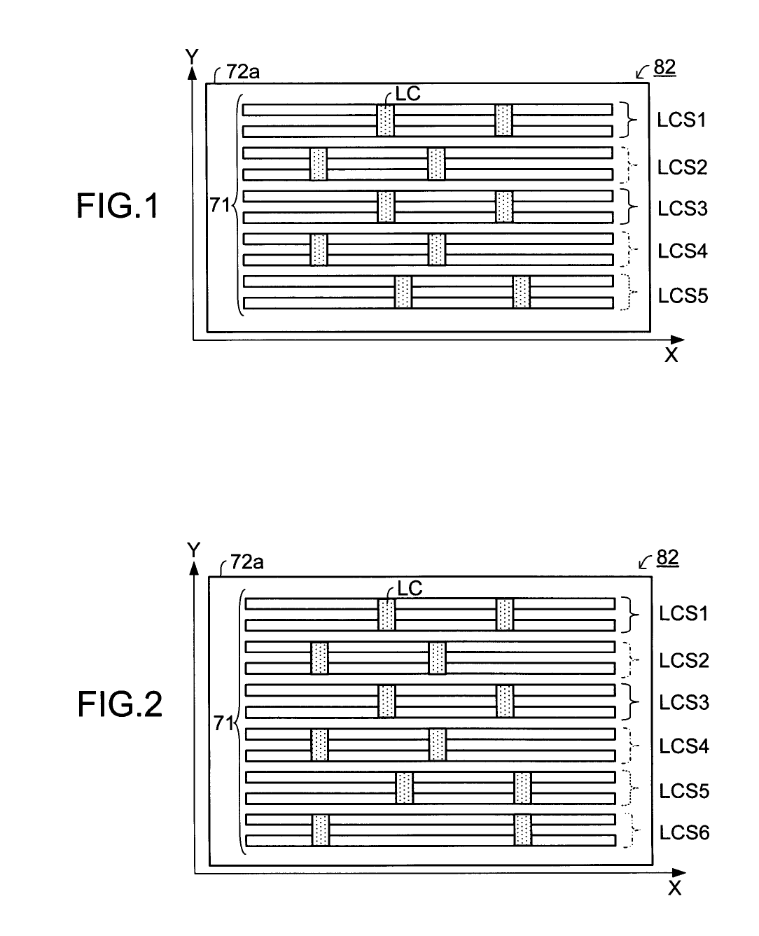

The vibrating fluorescent tubes 71 also resonate. Thus, they have a resonant frequency. The resonant frequency is changed due to the lamp clips LC holding the fluorescent tubes 71. Hence, the arrangement of the lamp clips LC in the fluorescent tubes 71 is important. Thus, the arrangement of the lamp clips LC will be described in detail below with reference to FIG. 1.

FIG. 1 is a schematic plan view showing the arrangement of the fluorescent tubes 71 in the backlight unit 82. In these figures, dotted portions represent the locations of the lamp clips LC. The lamp clip LC holds two fluorescent tubes 71 simultaneously.

In these figures, the X-direction and the Y-direction are also shown. In the following description, a plurality of lamp clips LC (that is, lamp clips LC holding the same fluorescent tubes 71) that are arranged in the same positions in the Y-direction and that are aligned in the X-direction are referred to as a lamp clip set LCS. The lamp clip set LCS is a plurality of lamp clips LC indicated by “}” (a wavy parenthesis) in the figure.

In the backlight unit 82 shown in FIG. 1, ten fluorescent tubes 71 are aligned. One lamp clip set LCS including two lamp clips LC holds fluorescent tubes 71 in group of two from the head of the rows. Hence, this backlight unit 82 includes five lamp clip sets LCS (LCS1 to LCS5).

Here, with respect to the arrangement of all the lamp clip sets LCS, lamp clip sets LCS in which the positions of lamp clips LC in the X-direction are the same are included. Then, pairs of these lamp clip sets LCS are indicated by using the same type of “}”.

Specifically, in the backlight unit 82 shown in FIG. 1, one pair of lamp clip sets LCS1 and LCS3 indicated by “}” shown in solid lines and one pair of lamp clip sets LCS2 and LCS4 indicated by “}” shown in alternate long and short dashed lines are included (two pairs of lamp clip sets LCS are included.) On the other hand, one lamp clip set LCS5 (indicated by “}” shown in dotted lines), which does not make a pair, is included.

This type of arrangement of the lamp clips LC is said to be random. This type of random arrangement of the lamp clips LC reduces noise produced due to the resonance of the fluorescent tubes 71. The reason for this is as follows.

The resonance of the fluorescent tubes 71 depends on the position of the lamp clips LC. Hence, the fluorescent tubes 71 held in the lamp clip set LCS1 have a resonant frequency λ depending on the lamp clips LC in the lamp clip set LCS1. Here, this resonant frequency λ is referred to as a resonant frequency λA.

The fluorescent tubes 71 held in the lamp clip set LCS2 have a resonant frequency λ depending on the lamp clips LC in the lamp clip set LCS2. This resonant frequency λ is referred to as a resonant frequency λB.

The fluorescent tubes 71 held in the lamp clip set LCS3, which makes a pair with the lamp clip set LCS1, have the resonant frequency λA. The fluorescent tubes 71 held in the lamp clip set LCS4, which makes a pair with the lamp clip set LCS2, have the resonant frequency λB.

As described above, the same resonant frequencies λA are present, and thus they are superimposed into a relatively large unusual noise. The same resonant frequencies λB are also superimposed into an unusual noise. In the backlight unit 82, the lamp clip set LCS5, which does not make a pair, is included. The fluorescent tubes 71 held in the lamp clip set LCS5 have a resonant frequency λ depending on the lamp clips LC in the lamp clip set LCS5 (this frequency is referred to as a resonant frequency λC.)

Then, in the backlight unit 82, three types of resonant frequencies λA, λB and λC are present. These different resonant frequencies λA, λB and λC are not superimposed. Hence, the backlight unit 82 includes ten fluorescent tubes 71, and, as compared with a backlight unit including only one or two types of resonant frequencies, an unusual sound is reduced.

Specifically, since, in the backlight unit 82, the arrangement of the lamp clips LC is random, the resonant frequencies of the vibrating fluorescent tubes 71 are displaced, with the result that an unusual sound produced due to the resonant frequencies is reduced. In other words, the resonant frequencies are spread, and a large number of resonant frequencies are not superimposed, with the result that the unusual sound is reduced.

### Embodiment 2

Embodiment 2 will be described. Members that have the same functions as those used in embodiment 1 are identified with common symbols, and their description will not be repeated.

In embodiment 1, the two pairs of lamp clip set LCS (LCS1 and LCS3, and LCS2 and LCS4) are present, and the one lamp clip set LCS5, which does not make a pair, is present. However, the arrangement of the lamp clips LC is not limited to this arrangement, and there are a large number of arrangements.

For example, as shown in FIG. 2, the number of lamp clip sets LCS that do not make a pair does not needs to be one and the number may be more than one. Specifically, the lamp clip sets LCS5 and LCS 6 (indicated by “}” shown in a dotted line and “}” shown in an alternate long and two short dashed line) may be included.

In this way, the fluorescent tubes 71 held by the pair of lamp clip sets LCS1 and LCS3 have the superimposed resonant frequencies λA, and the fluorescent tubes 71 held by the pair of lamp clip sets LCS2 and LCS4 have the superimposed resonant frequencies λB. The fluorescent tubes 71 held by the lamp clip set LCS5 have the resonant frequency λC different from the resonant frequencies λA and λB; the fluorescent tubes 71 held by the lamp clip set LCS6 have a resonant frequencies λD different from the resonant frequencies λA λB and λC.

Specifically, in this backlight unit 82, the four types of resonant frequencies λ are present. Thus, with this backlight unit 82, it is possible to reduce an unusual sound as compared with, for example, a backlight unit including only one, two or three types of resonant frequencies (in particular, when backlight units including the same number of fluorescent tubes 71 are compared, the significant effect of reducing an unusual sound is observed).

When a plurality of lamp clip sets LCS that do not make a pair are present, it is acceptable that at least parts of the positions of the lamp clips LC in the X-direction are different in the plurality of lamp clip sets LCS.

Specifically, in the plurality of lamp clip sets LCS that do not make a pair, lamp clips LC arranged in the same position in the X-direction may be included or the positions of all the lamp clips LC in the X-direction may be different.

In all the lamp clip sets, one pair of lamp clip sets LCS and at least two lamp clip sets LCS that do not make a pair may be included. Even in this case, in the backlight unit 82, the three types of resonant frequencies λA, λB and λC are present, and the different resonant frequencies λA, λB and λC are not superimposed.

### Embodiment 3

Embodiment 3 will be described. Members that have the same functions as those used in embodiments 1 and 2 are identified with common symbols, and their description will not be repeated.

In embodiments 1 and 2, the lamp clip sets LCS that do not make a pair are present. However, it is acceptable that all the lamp clip sets LCS are composed of pairs of lamp clip sets LCS. In particular, in all the lamp clip sets LCS, three or more pairs of lamp clip sets LCS are preferably included (three or more types of pairs are preferably present.)

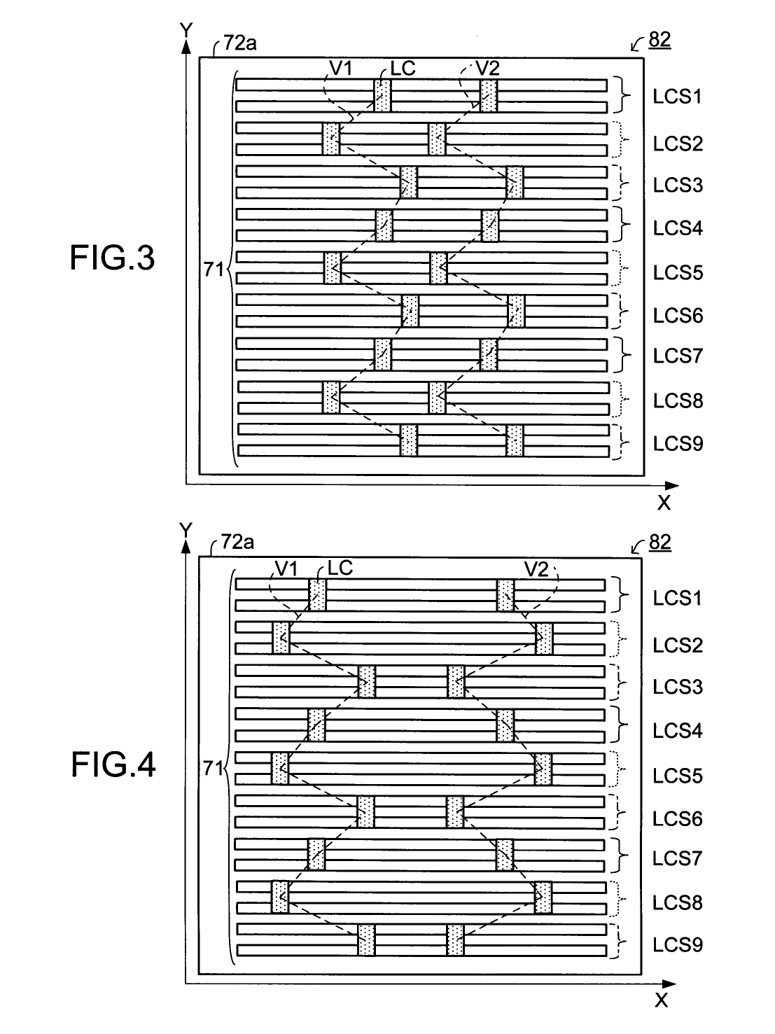

This is because, with this type of backlight unit 82 that includes three pairs of lamp clip sets LCS, it is possible to reduce an unusual sound as compared with the backlight unit 82 that includes one or two pairs of lamp clip sets LCS. Hence, various types of backlight units 82 that include three pairs of lamp clip sets LCS will be described below with reference to FIGS. 3 to 8.

In the backlight units 82 shown in FIGS. 3 to 8, nine lamp clip sets LCS (LCS1 to LCS9) are included. Three groups of lamp clip sets LCS in which the positions of the lamp clips LC in the X-direction are the same are included.

In the backlight units 82 shown in FIGS. 3 to 5, one group of three lamp clip sets LCS1, LCS4 and LCS7, one group of three lamp clip sets LCS2, LCS5 and LCS8 and one group of three lamp clip sets LCS3, LCS6 and LCS9 are included.

Within the lamp clip sets LCS1 to LCS3, the positions of the lamp clips LC in the X-direction are different in the lamp clip sets LCS. However, when the lamp clip sets LCS1 to LCS3 are considered to be one series, in all the lamp clip sets LCS1 to LCS9, three series of lamp clip sets LCS (LCS1 to LCS 3, LCS4 to LCS6 and LCS6 to LCS9) in which the positions of the lamp clips LC are the same are aligned. That is, in the backlight unit 82 shown in FIGS. 3 to 5, the lamp clip sets LCS are regularly aligned in the Y-direction.

Moreover, these backlight units 82 satisfy at least one of the following conditions.

Condition 1

A shape formed by connecting, along the Y-direction, the lamp clips LC arranged on one outermost end side of the fluorescent tubes 71 is referred to as an imaginary shape V1, and a shape formed by connecting, along the Y-direction, the lamp clips LC arranged on the other outermost end side of the fluorescent tubes 71 is referred to as an imaginary shape V2. Then, the imaginary shape V1 is not the same as the imaginary shape V2.

Condition 2

The imaginary shape 1 and the imaginary shape V2 are not axisymmetric, that is, non-axisymmetric.

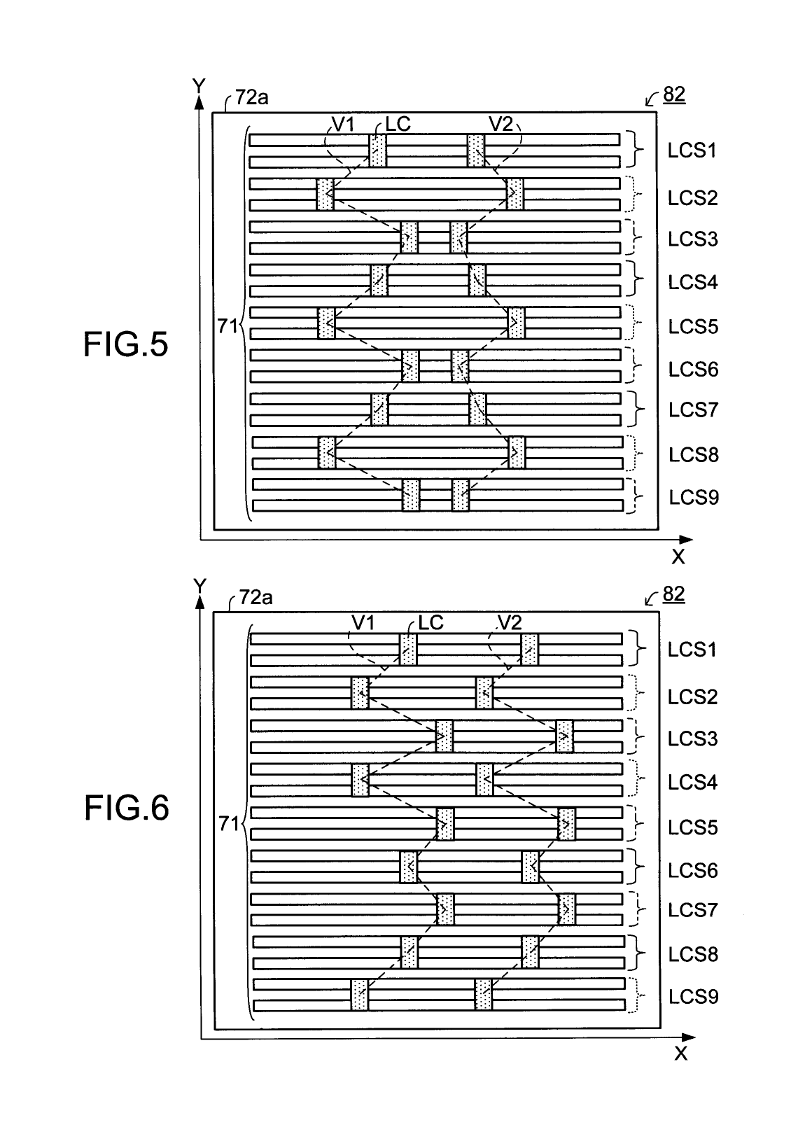

Then, in the backlight unit 82 shown in FIG. 3, the imaginary shape V1 and the imaginary shape V2 are the same as each other and are non-axisymmetric. In the backlight unit 82 shown in FIG. 4, the imaginary shape V1 and the imaginary shape V2 are different from each other and are axisymmetric. In the backlight unit 82 shown in FIG. 5, the imaginary shape V1 and the imaginary shape V2 are different from each other and are non-axisymmetric.

On the other hand, in the backlight unit 82 shown in FIG. 6, one group of three lamp clip sets LCS1, LCS 6 and LCS8, one group of three lamp clip sets LCS2, LCS 4 and LCS9 and one group of three lamp clip sets LCS3, LCS 5 and LCS7 are included.

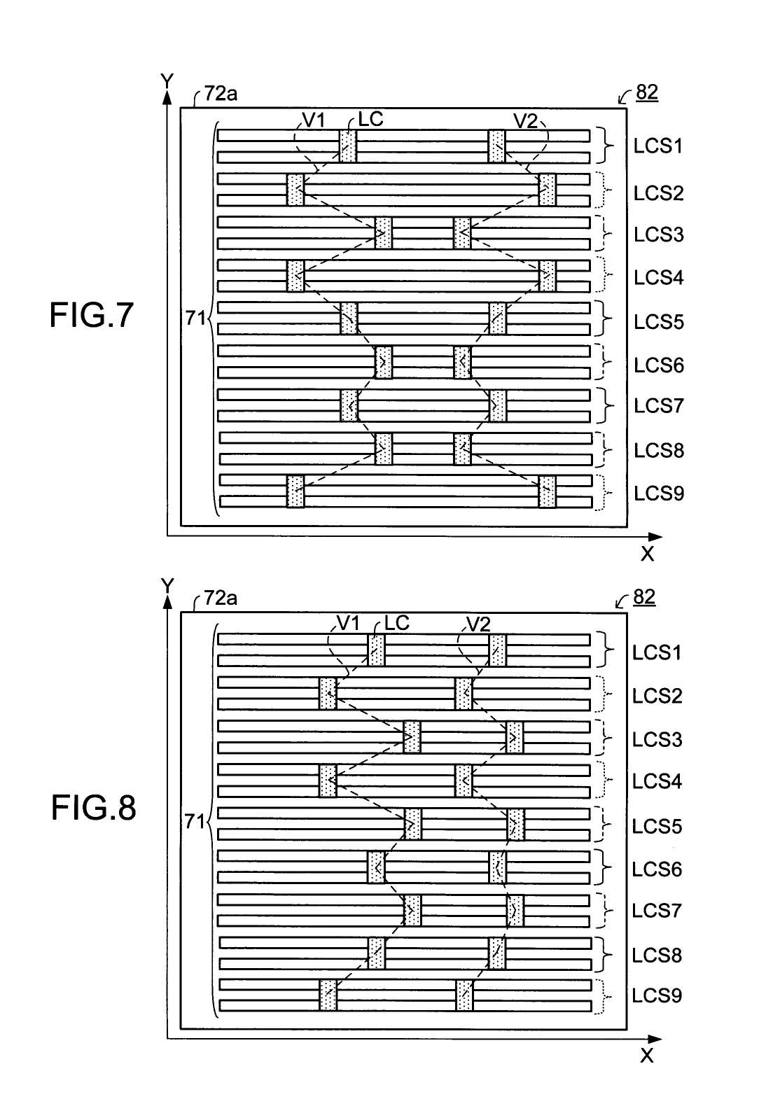

In the backlight unit 82 shown in FIG. 7, one group of three lamp clip sets LCS1, LCS 5 and LCS7, one group of three lamp clip sets LCS2, LCS 4 and LCS9 and one group of three lamp clip sets LCS3, LCS 6 and LCS8 are included.

In the backlight unit 82 shown in FIG. 8, as in the backlight unit 82 shown in FIG. 6, one group of three lamp clip sets LCS1, LCS 6 and LCS8, one group of three lamp clip sets LCS2, LCS 4 and LCS9 and one group of three lamp clip sets LCS3, LCS 5 and LCS7 are included.

In the backlight units 82 shown in FIGS. 6 to 8, as in the backlight units 82 shown in FIGS. 3 to 5, within the lamp clip sets LCS1 to LCS3, the positions of the lamp clips LC in the X-direction are different in the lamp clip sets LCS.

However, when the lamp clip sets LCS1 to LCS3 are considered to be one series, in all the lamp clip sets LCS1 to LCS9, series of lamp clip sets LCS (LCS1 to LCS 3, LCS4 to LCS6 and LCS6 to LCS9) in which the positions of the lamp clips LC are the same are not aligned.

In other words, between the series of lamp clip sets LCS1 to LCS3, the series of lamp clip sets LCS4 to LCS6 and the series of lamp clip sets LCS7 to LCS9 (between each of the series), the positions of the lamp clips LC in the X-direction are different. Thus, in the backlight units 82 shown in FIGS. 6 to 8, the lamp clip sets LCS are irregularly aligned in the Y-direction.

Then, these backlight units 82 shown in FIGS. 6 to 8 satisfy condition 3 below.

Condition 3

A plurality of lamp clip sets LCS aligned in the Y-direction are divided into a plurality of series, and, when those series are compared, the positions of the lamp clips LC in the X-direction are different.

In the backlight unit 82 shown in FIG. 6, the imaginary shape V1 and the imaginary shape V2 are the same as each other and are non-axisymmetric. In the backlight unit 82 shown in FIG. 7, the imaginary shape V1 and the imaginary shape V2 are different from each other and are axisymmetric. In the backlight unit 82 shown in FIG. 8, the imaginary shape V1 and the imaginary shape V2 are different from each other and are non-axisymmetric.

In the backlight units 82 described above and shown in FIGS. 3 to 8, three groups of lamp clip sets LCS are included. Specifically, these backlight units 82 include three groups of lamp clip sets LCS and satisfy any one of conditions 1 to 3. Due to the following reason, these backlight units 82 have the effect of reducing an unusual sound.

In other words, since, in these backlight units 82, the three groups of lamp clip sets LCS are included, three types of resonant frequencies λA, λB and λC are present in the backlight units 82. Thus, with these backlight units 82, it is possible to reduce an unusual sound as compared with, for example, a backlight unit including only one or two types of resonant frequencies (in particular, when backlight units including the same number of fluorescent tubes 71 are compared, the significant effect of reducing an unusual sound is observed).

### Embodiment 4

Embodiment 4 will be described. Members that have the same functions as those used in embodiments 1 to 3 are identified with common symbols, and their description will not be repeated. When backlight units including the same number of fluorescent tubes 71 are compared, the significant effect of reducing an unusual sound as will be described below is observed.

Embodiments 1 to 3 deal with only the backlight units 82 in which two lamp clips LC are aligned in the X-direction. However, no restrictions are imposed by this.

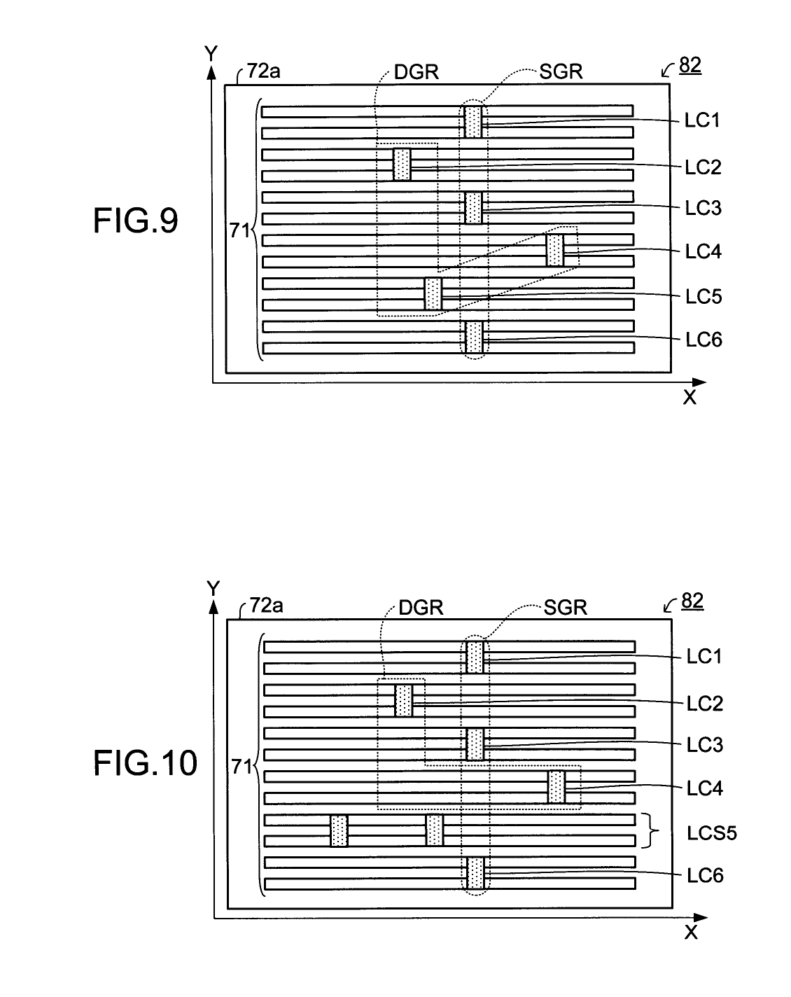

As shown in FIGS. 9 to 12, the backlight unit 82 in which one lamp clip is arranged in the X-direction may be employed. For example, FIG. 9 shows the backlight unit 82 in which only one lamp clip is arranged in the X-direction. Specifically, in this type of backlight unit 82, a plurality of lamp clips LC are arranged in different positions in the Y-direction and are arranged such that a single lamp limp is arranged in the X-direction.

The plurality of lamp clips LC are referred to as a large group, and then the large group includes the following small groups of lamp clips LC. That is, a small group SGR of single lamp clips LC arranged in the same position in the X-direction and a small group DGR of single lamp clips LC arranged in different positions in the X-direction are mixed.

In this way, the fluorescent tubes 71 held by the small group SGR of lamp clips LC1, LC3 and LC6 have superimposed resonant frequencies λA. On the other hand, the fluorescent tubes 71 held by the small group DGR of lamp clips LC2, LC4 and LC5 have different resonant frequencies λB, λC and λD.

Specifically, even in this backlight unit 82, the four types of resonant frequencies λ are present. Thus, with this backlight unit 82, it is possible to reduce an unusual sound as compared with, for example, a backlight unit including only one, two or three types of resonant frequencies.

As shown in FIG. 10, a small group SGR of lamp clips LC1, LC3 and LC6 arranged in the same positions in the X-direction, a small group DGR of lamp clips LC2 and LC4 arranged in different positions in the X-direction and one lamp clip set LCS5 may be included.

In this way, the fluorescent tubes 71 held by the small group SGR of lamp clips LC1, LC3 and LC6 have superimposed resonant frequencies λA. On the other hand, the fluorescent tubes 71 held by the small group DGR of lamp clips LC2 and LC4 have different resonant frequencies λB and λC. Furthermore, the fluorescent tubes 71 held by the lamp clip set LCS5 have the resonant frequency λD different from the resonant frequencies λA, λB and λC is present.

Thus, even with this backlight unit 82, since the four types of resonant frequencies λ are present, an unusual sound is reduced.

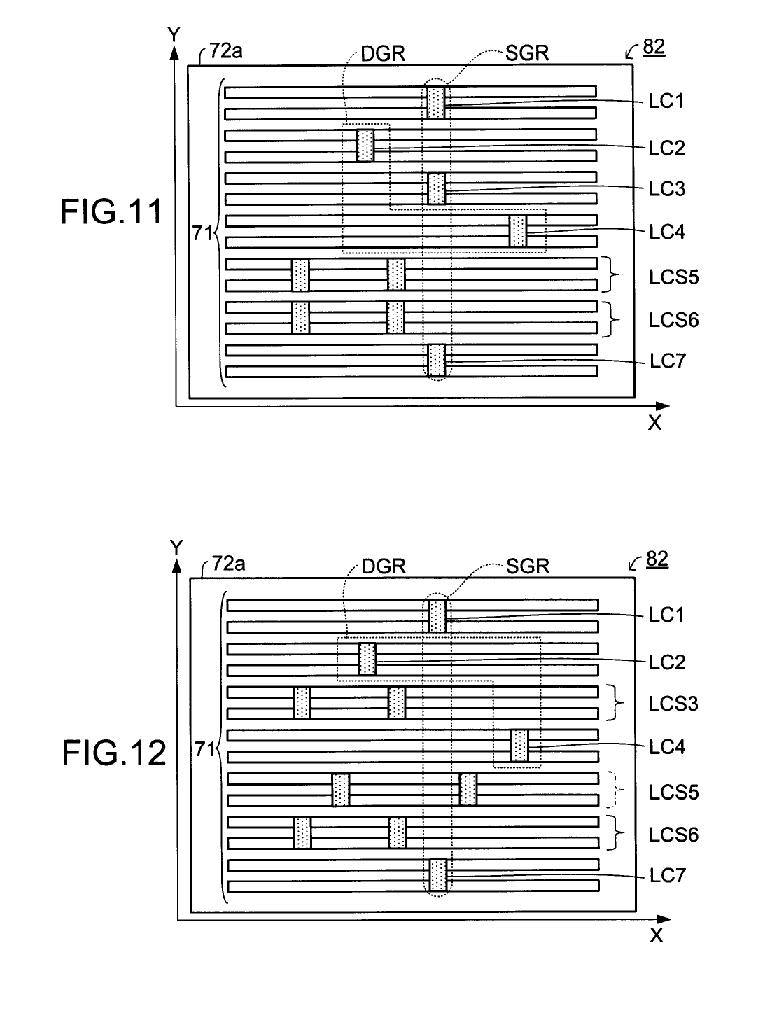

In the backlight unit 82 shown in FIG. 10, the number of lamp clip sets LCS is only one (LCS5), but no restrictions are imposed by this. For example, as shown in FIG. 11, a small group SGR of lamp clips LC1, LC3 and LC7 arranged in the same positions in the X-direction, a small group DGR of lamp clips LC2 and LC4 arranged in different positions in the X-direction and two lamp clip sets LCS5 and LCS6 may be included in a backlight unit 82.

In this way, the fluorescent tubes 71 held by the small group SGR of lamp clips LC1, LC3 and LC7 have superimposed resonant frequencies λA. On the other hand, the fluorescent tubes 71 held by the small group DGR of lamp clips LC2 and LC4 have different resonant frequencies λB and λC. Furthermore, the fluorescent tubes 71 held by a pair of lamp clip sets LCS5 and LCS6 have the resonant frequency λD different from the resonant frequencies λA, λB and λC.

Thus, even with this backlight unit 82, since the four types of resonant frequencies λ are present, an unusual sound is reduced.

In the backlight unit 82 shown in FIG. 11, the number of pairs of lamp clip sets LCS is one (LCS5 and LCS6), but no restrictions are imposed by this. A plurality of pairs of lamp clip sets LCS may be present.

Moreover, in addition to the small group SGR and the small group DGR, a pair of lamp clip sets LCS and a lamp clip set LCS that does not make a pair may be mixed in a backlight unit 82.

For example, as shown in FIG. 12, a small group SGR of lamp clips LC1 and LC7 arranged in the same positions in the X-direction, a small group DGR of lamp clips LC2 and LC4 arranged in different positions in the X-direction, a pair of two lamp clip sets LCS3 and LCS6 and one lamp clip set LCS5 that does not make a pair may be included in a backlight unit 82.

In this way, the fluorescent tubes 71 held by the small group SGR of lamp clips LC1 and LC7 have superimposed resonant frequencies λA. On the other hand, the fluorescent tubes 71 held by the small group DGR of lamp clips LC2 and LC4 have different resonant frequencies λB and λC. Furthermore, the fluorescent tubes 71 held by the pair of lamp clip sets LCS3 and LCS6 have the resonant frequency λD. The fluorescent tubes 71 held by the lamp clip set LCS5 that does not make a pair have the resonant frequency λE.

Specifically, in this backlight unit 82, the five types of resonant frequencies λ are present. Thus, with this backlight unit 82, it is possible to reduce an unusual sound as compared with, for example, a backlight unit including only one, two, three or four types of resonant frequencies.

In the backlight unit 82 shown in FIG. 12, the number of lamp clip sets LCS that do not make a pair is only one, but no restrictions are imposed by this. For example, in addition to the small group SGR and the small group DGR, pairs of lamp clip sets LCS and a plurality of lamp clip sets LCS that do not make a pair may be mixed in a backlight unit 82.

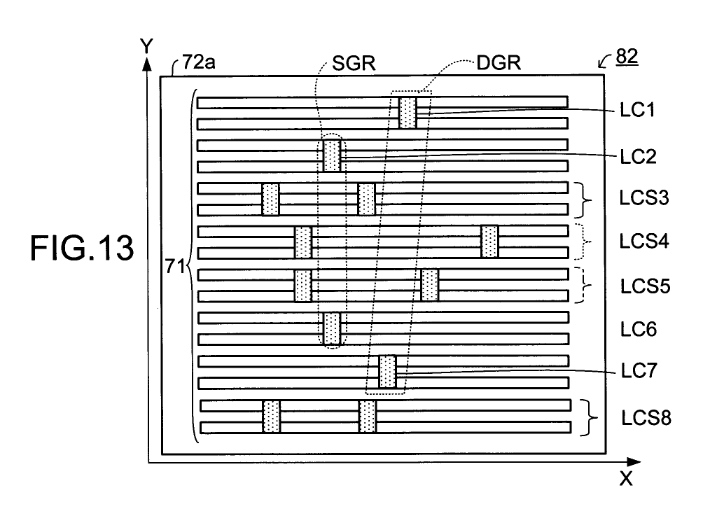

For example, as shown in FIG. 13, a small group SGR of lamp clips LC2 and

LC6 arranged in the same positions in the X-direction, a small group DGR of lamp clips LC1 and LC7 arranged in different positions in the X-direction, two pairs of lamp clip sets LCS3 and LCS8 and two lamp clip sets LCS 4 and LCS5 that do not make a pair may be included in a backlight unit 82.

In this way, the fluorescent tubes 71 held by the small group SGR of lamp clips LC2 and LC6 have superimposed resonant frequencies λA. On the other hand, the fluorescent tubes 71 held by the small group DGR of lamp clips LC1 and LC7 have different resonant frequencies λB and λC. Furthermore, the fluorescent tubes 71 held by the pair of lamp clip sets LCS3 and LCS8 have the resonant frequency λD. The fluorescent tubes 71 held by the lamp clip sets LCS 4 and LCS5 that do not make a pair have the resonant frequencies λE and λF.

Specifically, in this backlight unit 82, the six types of resonant frequencies λ are present. Thus, with this backlight unit 82, it is possible to reduce an unusual sound as compared with, for example, a backlight unit including only one, two, three, four or five types of resonant frequencies.

When a plurality of lamp clip sets LCS that do not make a pair are present, it is acceptable that at least parts of the positions of the lamp clips LC in the X-direction are different in the plurality of lamp clip sets LCS.

Specifically, in the plurality of lamp clip sets LCS that do not make a pair, lamp clips LC arranged in the same position in the X-direction may be included or the positions of all the lamp clips LC in the X-direction may be different.

### Other Embodiments

The present invention is not limited to the above embodiments, and many modifications are possible without departing from the spirit of the invention.

For example, in the backlight units 82 described above, at least three types of lamp clips LC arranged in different positions in the X-direction are included. However, in order for these backlight units 82 to be provided, pairs of lamp clip sets LCS and a small group SGR of lamp clips LC arranged in the same position in the X-direction are not necessarily needed.

Specifically, all the positions of lamp clips LC in the X-direction may be different from each other so that at least three different types of positions in the X-direction are achieved.

The lamp clip LC is not limited to the two-pronged lamp clip that can hold two fluorescent tubes 71 simultaneously. Specifically, the lamp clip LC may be configured to hold three fluorescent tubes 71 simultaneously or one fluorescent tube 71.

Although the above description deals with the case where one lamp clip LC or two lamp clips LC are aligned in the X-direction, no restrictions are imposed by this. Specifically, three or more lamp clips LC may be aligned in the X-direction.

1. A backlight unit including a plurality of linear light sources that are aligned and a plurality of holding clips that hold the linear light sources,
wherein, when a direction in which the linear light sources extend is an X-direction and a direction in which the linear light sources are aligned is a Y-direction, in a plane defined by the X-direction and the Y-direction, at least three types of holding clips arranged in different positions in the X-direction are included.

2. The backlight unit of claim 1,
wherein, when a plurality of holding clips arranged in a same position in the Y-direction and aligned in the X-direction are a holding clip set, in all holding clip sets formed with the holding clip set, a plurality of pairs of holding clip sets in which positions of the holding clips in the X-direction are a same are included and at least one holding clip set other than the pairs are included.

3. The backlight unit of claim 2,
wherein, when a plurality of holding clip sets other than the pairs are included, in the plurality of holding clip sets, at least parts of the positions of the holing clips in the X-direction are different.

4. The backlight unit of claim 1,
wherein, when a plurality of holding clips arranged in a same position in the Y-direction and aligned in the X-direction are a holding clip set, in all holding clip sets formed with the holding clip set, one pair of holding clip sets in which positions of the holding clips in the X-direction are a same is included and at least two holding clip sets other than the pair are included.

5. The backlight unit of claim 1,
wherein, when a plurality of holding clips arranged in a same position in the Y-direction and aligned in the X-direction are a holding clip set, in all holding clip sets formed with the holding clip set, three or more pairs of holding clip sets in which positions of the holding clips in the X-direction are a same are included.

6. The backlight unit of claim 1,
wherein, in the plurality of holding clips, a large group of single holding clips which are arranged in different positions in the Y-direction and in which a single holding clip is arranged in the X-direction are included, and, in the large group of single holding clips, a small group of single holding clips arranged in a same position in the X-direction and a small group of single holding clips arranged in different positions in the X-direction are mixed.

7. The backlight unit of claim 6,
wherein, in the plurality of holding clips, at least one holding clip set which is arranged in a same position in the Y-direction and in which a plurality of holding clip sets are aligned in the X-direction is included.

8. The backlight unit of claim 7,
wherein a plurality of holding clip sets are included, and, in all the holding clip sets, at least one pair of holding clip sets in which positions of the holding clips in the X-direction are a same is included.

9. The backlight unit of claim 8,
wherein at least one holding clip set other than the pair is included.

10. The backlight unit of claim 9,
wherein a plurality of holding clip sets other than the pair are included, and, in the plurality of holding clip sets, at least parts of positions of the holing clips in the X-direction are different.

11. The backlight unit of claim 1,
wherein all positions of the holding clips in the X-direction are different.

12. The backlight unit of claim 1,
wherein a supporting stage that supports the linear light sources is arranged at both ends of the linear light sources.

13. A liquid crystal display device comprising:
the backlight unit of claim 1; and
a liquid crystal display panel that receives light from the backlight unit.

14. A liquid crystal display device comprising:
the backlight unit of claim 2; and
a liquid crystal display panel that receives light from the backlight unit.

15. A liquid crystal display device comprising:
the backlight unit of claim 3; and
a liquid crystal display panel that receives light from the backlight unit.

16. A liquid crystal display device comprising:
the backlight unit of claim 4; and
a liquid crystal display panel that receives light from the backlight unit.

17. A liquid crystal display device comprising:
the backlight unit of claim 5; and
a liquid crystal display panel that receives light from the backlight unit.

18. A liquid crystal display device comprising:
the backlight unit of claim 6; and
a liquid crystal display panel that receives light from the backlight unit.

19. A liquid crystal display device comprising:
the backlight unit of claim 7; and
a liquid crystal display panel that receives light from the backlight unit.

20. A liquid crystal display device comprising:
the backlight unit of claim 8; and
a liquid crystal display panel that receives light from the backlight unit.

21. A liquid crystal display device comprising:
the backlight unit of claim 9; and
a liquid crystal display panel that receives light from the backlight unit.

22. A liquid crystal display device comprising:
the backlight unit of claim 10; and
a liquid crystal display panel that receives light from the backlight unit.

23. A liquid crystal display device comprising:
the backlight unit of claim 11; and
a liquid crystal display panel that receives light from the backlight unit.

24. A liquid crystal display device comprising:
the backlight unit of claim 12; and
a liquid crystal display panel that receives light from the backlight unit.
